(19) United States
(12) Patent Application Publication
(10) Pub. No.: US 2016/0122508 A1
(43) Pub. Date: May 5, 2016

(54) POLYOLEFIN RESIN PACKAGING MATERIAL

(71) Applicant: ADEKA CORPORATION, Tokyo (JP)

(72) Inventors: Atsushi SAKAI, Saitama-shi (JP); Naoko TANJI, Saitama-shi (JP); Naoshi KAWAMOTO, Saitama-shi (JP)

(73) Assignee: ADEKA CORPORATION, Tokyo (JP)

(21) Appl. No.: 14/894,462

(22) PCT Filed: May 28, 2014
(86) PCT No.: PCT/JP2014/064138

§ 371 Date: Nov. 27, 2015

(30) Foreign Application Priority Data
May 31, 2013 (JP) 2013-115466

(51) Int. Cl. C08K 5/1575; B65D 65/38; C08K 5/521

(52) U.S. Cl. CPC C08K 5/1575; C08K 5/521; B65D 65/38

(57) ABSTRACT

Provided is a polyolefin resin packaging material having excellent clarity, heat resistance, bleed resistance and low-odor properties. The polyolefin resin packaging material is obtained by molding a polyolefin-based resin composition that comprises, with respect to 100 parts by mass of a polyolefin-based resin:
0.01 to 0.5 parts by mass of a benzylidene sorbitol compound represented by the following Formula (1):

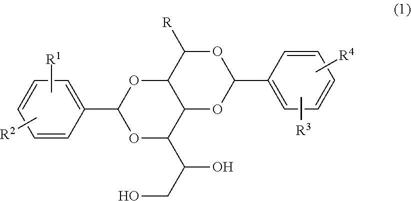

(wherein, R represents a hydrogen atom or the like; and R¹, R², R³ and R⁴ each independently represent a hydrogen atom or the like); and
0.01 to 0.5 parts by mass of a metal phosphate represented by the following Formula (2):

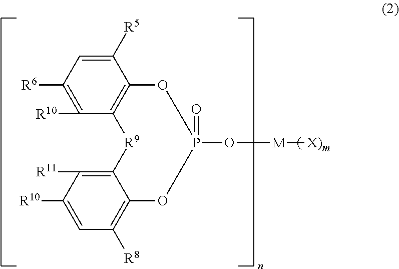

(wherein, R⁵ and R⁸ each independently represent an alkyl group having 1 to 8 carbon atoms or the like; R⁶ and R⁷ each independently represent a hydrogen atom or the like; R⁹ represents a direct bond or the like; R¹⁰ and R¹¹ each independently represent a hydrogen atom or the like; M represents an alkali metal or the like; n represents an integer of 1 to 3; and m represents an integer of 0 to 2).

### TECHNICAL FIELD

The present invention relates to a polyolefin resin packaging material having excellent clarity and heat resistance as well as low-contamination and low-odor properties.

### BACKGROUND ART

Polyolefin-based resins are inexpensive and have excellent processability and light weight properties; therefore, they are widely used in packaging materials such as food packaging containers and wardrobe cases.

However, since polyolefin-based resins are clearer than acrylic resins and styrene-based resins, there are problems that, for example, when they are made into thick molded articles such as wardrobe cases, the contents therein are not clearly seen, while thin molded articles thereof have insufficient strength and are thus deformed when stacked on top of each other.

In addition, in food packaging applications, it is required that the physical properties be maintained over a broad temperature range so that the molded articles can handle refrigeration and heating by a microwave oven. Particularly, in recent years, since utilization of dish washers exposes the molded articles to high temperature and high humidity conditions, a high resistance to such use environment is required.

Moreover, in food products and electronic components, adhesion of a volatile substance originating from a packaging material may affect the taste of the content, cause an offensive smell and/or influence the operation of an electronic device or the like; therefore, it is required that the packaging material have low-contamination properties. Furthermore, for the protection of the content against deterioration by oxidation and corrosion due to moisture, it is also necessary that the packaging material have gas barrier properties.

Conventionally, for an improvement of the physical properties of polyolefin-based resins such as clarity and impact resistance strength as well as shortening of the molding cycle, as a nucleating agent or a clarifying agent, the use of a metal benzoate, an aromatic metal phosphate, a dibenzylidene sorbitol compound, a metal (bi)cycloalkane dicarboxylate or the like has been examined.

Patent Document 1 proposes a polypropylene-based packaging film comprising a clarifying agent, MILLAD NX8000 manufactured by Milliken & Company, as a dibenzylidene sorbitol-based clarifying agent. Patent Documents 2 and 3 disclose clear thin-walled molded articles of 1 mm or less in thickness that comprise a dibenzylidene sorbitol-based clarifying agent.

### RELATED ART DOCUMENTS

### Patent Documents

Patent Document 1: Japanese Unexamined Patent Application Publication No. 2010-24428

Patent Document 2: Japanese Unexamined Patent Application Publication No. 2010-248438

Patent Document 3: Japanese Unexamined Patent Application Publication No. 2010-254874

### SUMMARY OF THE INVENTION

### Problems to be Solved by the Invention

The method described in Patent Document 1 aims at producing a polypropylene-based film having excellent clarity and gloss with an improved odor; however, no disclosure is made with regard to the heat resistance. The method described in Patent Document 2 was devised for attaining clarity and low odor and inhibiting deformation (warping) of the resulting molded article; however, no disclosure is made with regard to the heat resistance and low-contamination properties. Patent Document 3 shows that the molded illumination cover thereof has excellent clarity and deflection temperature under load (° C.); however, no disclosure is made with regard to the odor and low-contamination properties.

In view of the above, an object of the present invention is to provide a polyolefin resin packaging material having excellent clarity, heat resistance, bleed resistance and low-odor properties.

### Means for Solving the Problems

The present inventors intensively studied to solve the above-described problems and discovered that, the above-described problems can be solved by incorporating a specific benzylidene sorbitol compound and a specific metal phosphate each in an amount of 0.01 to 0.5 parts by mass with respect to 100 parts by mass of a polyolefin-based resin, thereby completing the present invention.

That is, the polyolefin resin packaging material of the present invention is obtained by molding a polyolefin-based resin composition comprising, with respect to 100 parts by mass of a polyolefin-based resin:

0.01 to 0.5 parts by mass of a benzylidene sorbitol compound represented by the following Formula (1):

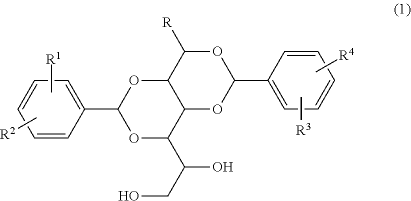

(wherein, R represents a hydrogen atom or an alkyl group having 1 to 4 carbon atoms; and R¹, R², R³ and R⁴ each independently represent a hydrogen atom, a halogen atom, a cyano group or an alkyl group having 1 to 4 carbon atoms); and

0.01 to 0.5 parts by mass of a metal phosphate represented by the following Formula (2):

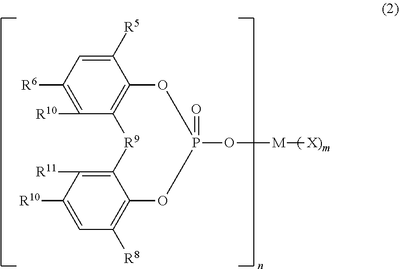

(wherein, R⁵ and R⁸ each independently represent an alkyl group having 1 to 8 carbon atoms, or a cycloalkyl, aryl, alkylaryl or arylalkyl group having 6 to 12 carbon atoms; R⁶ and R⁷ each independently represent a hydrogen atom, an alkyl group having 1 to 8 carbon atoms, or a cycloalkyl, aryl, alkylaryl or arylalkyl group having 6 to 12 carbon atoms; R⁹ represents a direct bond or an alkylidene group having 1 to 4 carbon atoms; R¹⁰ and R¹¹ each independently represent a hydrogen atom or a methyl group; M represents an atom of an alkali metal, an alkaline earth metal, zinc or aluminum; n represents an integer of 1 to 3; m represents an integer of 0 to 2; when M is an alkali metal, n is 1 and m is 0; when M is an alkaline earth metal or zinc, X is a hydroxy group and m is 1 if n is 1, and m is 0 if n is 2; and when M is aluminum, m is 2 if n is 1, m is 1 if n is 2, with X being a hydroxy group in both of these cases, and m is 0 if n is 3).

In the polyolefin resin packaging material of the present invention, it is preferred that the blending ratio of the compound represented by the Formula (1) and the compound represented by the Formula (2), the compound represented by the Formula (1)/the compound represented by the Formula (2), be 20/1 to 1/4.

The polyolefin resin packaging material of the present invention is suitable as a clear thin-walled molded article.

The polyolefin resin packaging material of the present invention is suitable as a clear thick-walled molded article.

The polyolefin resin packaging material of the present invention is suitable as an electrical/electronic component transport case.

The polyolefin resin packaging material of the present invention is suitable as a food storage container.

### Effects of the Invention

According to the present invention, a polyolefin resin packaging material having excellent clarity and heat resistance as well as low-contamination and low-odor properties can be provided.

### MODE FOR CARRYING OUT THE INVENTION

The polyolefin resin packaging material of the present invention will now be described in detail.

Examples of the polyolefin-based resin used in the polyolefin resin packaging material of the present invention include α-olefin polymers such as low-density polyethylenes, linear low-density polyethylenes, high-density polyethylenes, isotactic polypropylenes, syndiotactic polypropylenes, hemi-isotactic polypropylenes, cycloolefin polymers, stereo block polypropylenes, poly-3-methyl-1-butene, poly-3-methyl-1-pentene and poly-4-methyl-1-pentene; and α-olefin copolymers such as ethylene/propylene block or random copolymers.

The method of producing the polyolefin-based resin is not particularly restricted and the polyolefin-based resin can be produced by a known method. A Ziegler catalyst, a Ziegler-Natta catalyst, a metallocene catalyst and a variety of other polymerization catalysts can be used. If desired, a co-catalyst, a catalyst carrier and/or a chain transfer agent may also be used. Further, the polyolefin-based resin can be produced by appropriately selecting, in various polymerization methods such as vapor-phase polymerization, solution polymerization, emulsion polymerization and bulk polymerization, the polymerization conditions such as temperature, pressure, concentration, flow rate and removal of catalyst residue that yield a resin having physical properties suitable for a packaging material or a resin having physical properties suitable for molding of a packaging material. The properties of the polyolefin-based resins, such as number-average molecular weight, weight-average molecular weight, molecular weight distribution, melt flow rate, melting point, melting peak temperature, stereoregularity (e.g., isotacticity or syndiotacticity), presence/absence and degree of branching, specific gravity, ratio of a component(s) dissolving in various solvents, haze, gloss, impact strength, bending modulus of elasticity and Olsen rigidity, as well as whether or not the respective physical property values satisfy a specific formula, can be appropriately selected such that the polyolefin-based resin have properties suitable for a packaging material or suitable for molding of a packaging material.

Among the above-described polyolefin-based resins, polypropylene resins in which the nucleating agents used in the present invention show a prominent effect are preferred and, for example, polypropylene, an ethylene/propylene block or random copolymer, a non-ethylene α-olefin/propylene block or random copolymer, and a mixture of these propylene-based polymers and other α-olefin polymer can be particularly preferably used.

The polyolefin resin packaging material of the present invention is characterized by comprising, as nucleating agents: 0.01 to 0.5 parts by mass of a benzylidene sorbitol compound represented by the Formula (1) and 0.01 to 0.5 parts by mass of an alkali metal salt of aromatic organic phosphoric acid ester, which is represented by the Formula (2), with respect to 100 parts by mass of the polyolefin-based resin.

Examples of the alkyl group having 1 to 4 carbon atoms represented by R¹, R², R³, R⁴ and R in the Formula (1) include a methyl group, an ethyl group, a propyl group, an isopropyl group, a butyl group, a sec-butyl group, a tert-butyl group and an isobutyl group. Examples of the halogen atom represented by R¹, R², R³ and R⁴ in the Formula (1) include fluorine, chlorine, bromine and iodine.

Examples of the benzylidene sorbitol compound which is represented by the Formula (1) and used in the present invention include the following compounds. However, the present invention is not restricted by the following compounds.

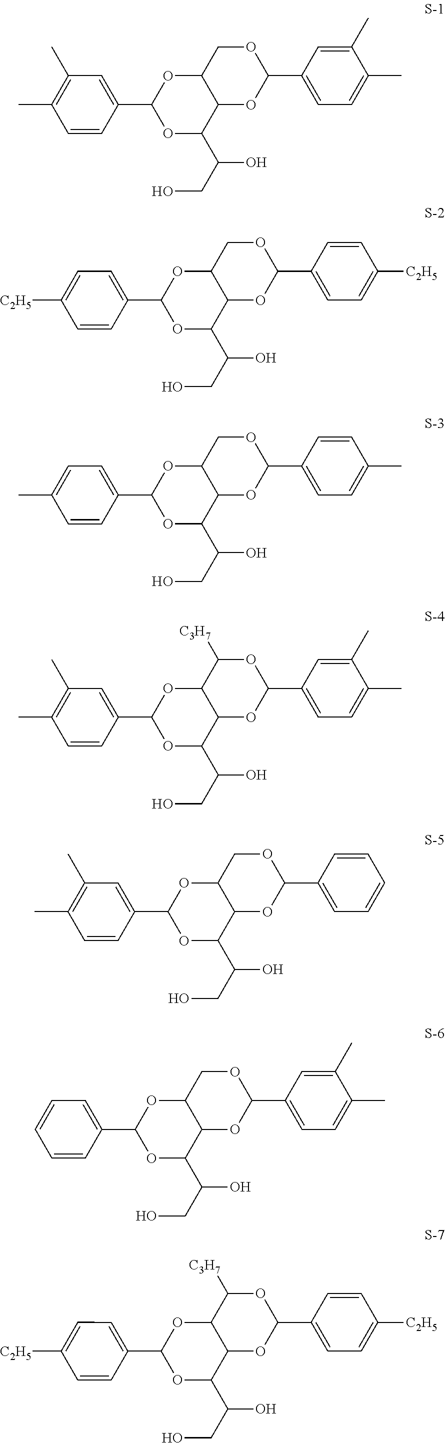

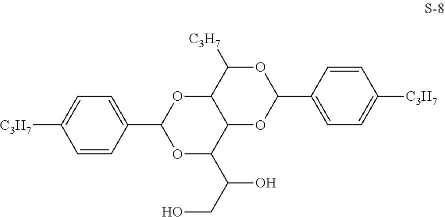

Examples of the alkyl group having 1 to 8 carbon atoms represented by R⁵ to R⁸ in the Formula (2) include, in addition to the alkyl groups exemplified above, a pentyl group, a tert-pentyl group, a hexyl group, a heptyl group, an octyl group, an isooctyl group, a tert-octyl group and a 2-ethylhexyl group, among which a tert-butyl group is particularly preferred.

Examples of the cycloalkyl group having 6 to 12 carbon atoms represented by R⁵ to R⁸ in the Formula (2) include a cyclohexyl group, a cycloheptyl group, a cyclooctyl group, a cyclononyl group and a cyclodecyl group, and the hydrogen atoms in the cycloalkyl group are optionally substituted with an alkyl group, an alkoxy group, an alkenyl group, an alkenyloxy group, a hydroxy group or a cyano group.

Examples of the aryl group having 6 to 12 carbon atoms represented by R⁵ to R⁸ in the Formula (2) include a phenyl group and a naphthyl group, and the aryl group is optionally substituted with an alkyl group, an alkoxy group, a halogen atom, a hydroxy group, a nitro group, a cyano group or an amino group.

Examples of the alkylaryl group or arylalkyl group having 6 to 12 carbon atoms which is represented by R⁵ to R⁸ in the Formula (2) include those groups in which any of the above-described alkyl groups and any of the above-described aryl groups are linked together.

Examples of the alkylidene group having 1 to 4 carbon atoms represented by R⁹ in the Formula (2) include a methylidene group, an ethylidene group, a propylidene group and a butylidene group. These alkylidene groups are optionally substituted with an alkyl group.

Examples of the alkali metal represented by M in the Formula (2) include lithium, sodium and potassium, among which sodium and lithium are particularly preferred.

Examples of the alkaline earth metal represented by M in the Formula (2) include beryllium, magnesium, calcium, strontium, barium and radium, among which calcium and magnesium are particularly preferred.

Examples of the metal phosphate represented by the Formula (2) include the following compounds. However, the present invention is not restricted by the following compounds.

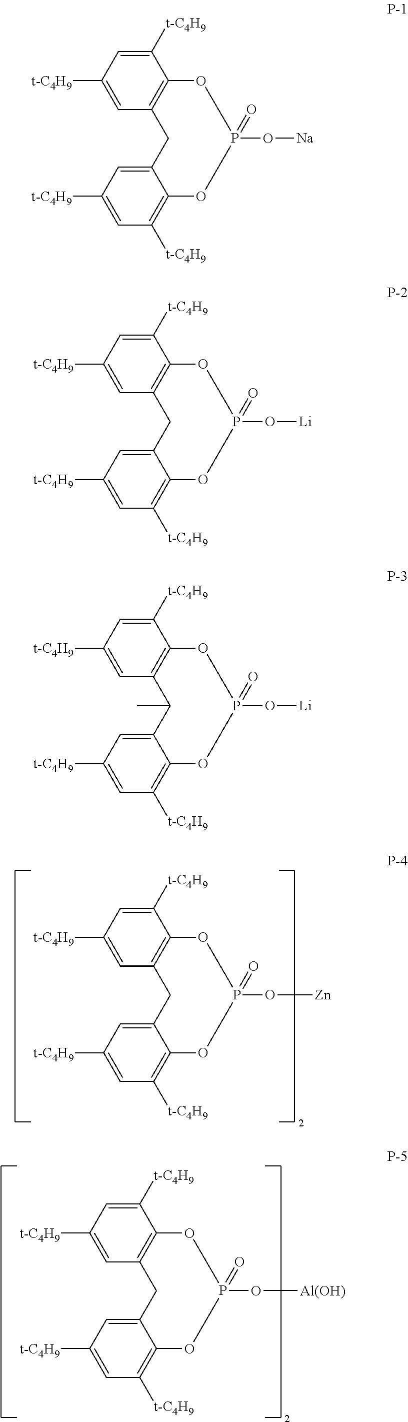

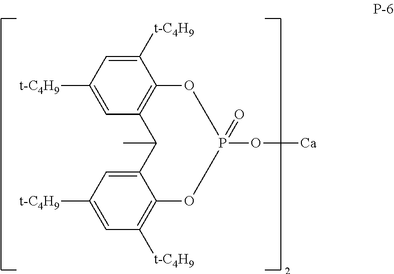

In the present invention, it is preferred that the benzylidene sorbitol compound represented by the Formula (1) and the metal phosphate represented by the Formula (2) be incorporated at a ratio, (1)/(2), of 20/1 to 1/4. When the ratio is higher than this range, the resulting molded article may not have sufficient clarity.

Further, in the polyolefin resin packaging material of the present invention, in addition to the compounds represented by the Formula (1) or (2), other additive(s) may also be added in such a range that does not impair the effects of the present invention.

Examples of such other additives include a phenolic antioxidant, a phosphorus-based antioxidant, a thioether-based antioxidant, an ultraviolet absorber, a hindered amine compound, a flame retardant, a nucleating agent other than those represented by the Formula (1) or (2), a filler, a lubricant, an antistatic agent, a heavy metal inactivator, a metallic soap, a hydrotalcite, a pigment, a dye, a plasticizer, an anti-blocking agent and a mineral oil.

Examples of the phenolic antioxidant include 2,6-di-tert-butyl-4-ethylphenol, 2-tert-butyl-4,6-dimethylphenol, styrenated phenol, 2,2′-methylene-bis(4-ethyl-6-tert-butylphenol), 2,2′-thiobis-(6-tert-butyl-4-methylphenol), 2,2′-thiodiethylene-bis[3-(3,5-di-tert-butyl-4-hydroxyphenyl)propionate], 2-methyl-4,6-bis(octylsulfanylmethyl)phenol, 2,2′-isobutylidene-bis(4,6-dimethylphenol), isooctyl-3-(3,5-di-tert-butyl-4-hydroxyphenyl)propionate, N,N′-hexane-1,6-diylbis[3-(3,5-di-tert-butyl-4-hydroxyphenyl)propionamide, 2,2′-oxamide-bis[ethyl-3-(3,5-di-tert-butyl-4-hydroxyphenyl)propionate], 2-ethylhexyl-3-(3′,5′-di-tert-butyl-4′-hydroxyphenyl)propionate, 2,2′-ethylene-bis(4,6-di-tert-butylphenol), 3,5-bis(1,1-dimethylethyl)-4-hydroxy-benzenepropanoate, C13-15 alkyl esters, 2,5-di-tert-amylhydroquinone, hindered phenol polymer (AO.OH998 (trade name), manufactured by ADEKA Palmarole), 2,2′-methylene-bis[6-(1-methylcyclohexyl)-p-cresol], 2-tert-butyl-6-(3-tert-butyl-2-hydroxy-5-methylbenzyl)-4-methylphenyl acrylate, 2-[1-(2-hydroxy-3,5-di-tert-pentylphenyl)ethyl]-4,6-di-tert-pentylphenyl acrylate, 6-[3-(3-tert-butyl-4-hydroxy-5-methyl)propoxy]-2,4,8,10-tetra-tert-butylbenzo[d,f][1,3,2]-dio xaphosphepin, hexamethylene-bis[3-(3,5-di-tert-butyl-4-hydroxyphenyl)propionate, calcium bis[monoethyl(3,5-di-tert-butyl-4-hydroxybenzyl)phosphonate, a reaction product between 5,7-bis(1,1-dimethylethyl)-3-hydroxy-2(3H)-benzofuranone and o-xylene, 2,6-di-tert-butyl-4-(4,6-bis(octylthio)-1,3,5-triazine-2-ylamino)phenol, DL-a-tocophenol (vitamin E), 2,6-bis(α-methylbenzyl)-4-methylphenol, bis[3,3-bis-(4′-hydroxy-3′-tert-butyl-phenyl)butyric acid]glycol ester, 2,6-di-tert-butyl-p-cresol, 2,6-diphenyl-4-octadecyloxyphenol, stearyl(3,5-di-tert-butyl-4-hydroxyphenyl)propionate, distearyl(3,5-di-tert-butyl-4-hydroxybenzyl)phosphonate, tridecyl-3,5-di-tert-butyl-4-hydroxybenzyl thioacetate, thiodiethylene-bis[(3,5-di-tert-butyl-4-hydroxyphenyl)propionate], 4,4′-thiobis(6-tert-butyl-m-cresol), 2-octylthio-4,6-di(3,5-di-tert-butyl-4-hydroxyphenoxy)-s-triazine, 2,2′-methylene-bis(4-methyl-6-tert-butylphenol), bis[3,3-bis(4-hydroxy-3-tert-butylphenyl)butyric acid]glycol ester, 4,4′-butylidene-bis(2,6-di-tert-butylphenol), 4,4′-butylidene-bis(6-tert-butyl-3-methylphenol), 2,2′-ethylidene-bis(4,6-di-tert-butylphenol), 1,1,3-tris(2-methyl-4-hydroxy-5-tert-butylphenyl)butane, bis[2-tert-butyl-4-methyl-6-(2-hydroxy-3-tert-butyl-5-methylbenzyl)phenyl]terephthalate, 1,3,5-tris(2,6-dimethyl-3-hydroxy-4-tert-butylbenzyl)isocyanurate, 1,3,5-tris(3,5-di-tert-butyl-4-hydroxybenzyl)isocyanurate, 1,3,5-tris(3,5-di-tert-butyl-4-hydroxybenzyl)-2,4,6-trimethylbenzene, 1,3,5-tris[(3,5-di-tert-butyl-4-hydroxyphenyl)propionyloxyethyl]isocyanurate, tetrakis[methylene-3-(3′,5′-di-tert-butyl-4′-hydroxyphenyl)propionate]methane, 2-tert-butyl-4-methyl-6-(2-acryloyloxy-3-tert-butyl-5-methylbenzyl)phenol, 3,9-bis[2-(3-tert-butyl-4-hydroxy-5-methylhydrocinnamoyloxy)-1,1-dimethylethyl]-2,4,8,10-t etraoxaspiro[5.5]undecane, and triethylene glycol-bis[β-(3-tert-butyl-4-hydroxy-5-methylphenyl)propionate].

Examples of the phosphorus-based antioxidant include diisooctyl phosphite, heptakis triphosphite, triisodecyl phosphite, diphenyl phosphite, diphenyl isooctyl phosphite, diisooctylphenyl phosphite, diphenyl tridecyl phosphite, triisooctyl phosphite, trilauryl phosphite, tris(dipropylene glycol)phosphite, diisodecyl pentaerythritol diphosphite, dioleyl hydrogen phosphite, trilauryl trithiophosphite, bis(tridecyl)phosphite, tris(isodecyl)phosphite, tris(tridecyl)phosphite, diphenyldecyl phosphite, dinonylphenyl-bis(nonylphenyl)phosphite, poly(dipropylene glycol)phenyl phosphite, tetraphenyldipropyl glycol diphosphite, trisnonylphenyl phosphite, tris(2,4-di-tert-butylphenyl)phosphite, tris(2,4-di-tert-butyl-5-methylphenyl)phosphite, tris[2-tert-butyl-4-(3-tert-butyl-4-hydroxy-5-methylphenylthio)-5-methylphenyl]phosphite, tridecyl phosphite, octyldiphenyl phosphite, di(decyl)monophenyl phosphite, distearyl pentaerythritol diphosphite, a mixture of distearyl pentaerythritol and calcium stearate, alkyl(C10) bisphenol-A phosphite, di(tridecyl)pentaerythritol diphosphite, di(nonylphenyl)pentaerythritol diphosphite, bis(2,4-di-tert-butylphenyl)pentaerythritol diphosphite, bis(2,6-di-tert-butyl-4-methylphenyl)pentaerythritol diphosphite, bis(2,4,6-tri-tert-butylphenyl)pentaerythritol diphosphite, bis(2,4-dicumylphenyl)pentaerythritol diphosphite, tetraphenyl-tetra(tridecyl)pentaerythritol tetraphosphite, bis(2,4-di-tert-butyl-6-methylphenyl)ethyl phosphite, tetra(tridecyl)isopropylidene diphenol diphosphite, tetra(tridecyl)-4,4′-n-butylidene-bis(2-tert-butyl-5-methylphenol)diphosphite, hexa(tridecyl)-1,1,3-tris(2-methyl-4-hydroxy-5-tert-butylphenyl)butane triphosphite, tetrakis(2,4-di-tert-butylphenyl)biphenylene diphosphonite, 9,10-dihydro-9-oxa-10-phosphaphenanthrene-10-oxide, (1-methyl-1-propanyl-3-ylidene)-tris(2-1,1-dimethylethyl)-5-methyl-4,1-phenylene)hexatride cyl phosphite, 2,2′-methylene-bis(4,6-tert-butylphenyl)-2-ethylhexyl phosphite, 2,2′-methylene-bis(4,6-di-tert-butylphenyl)-octadecyl phosphite, 2,2′-ethylidene-bis(4,6-di-tert-butylphenyl)fluorophosphite, 4,4′-butylidene-bis(3-methyl-6-tert-butylphenylditridecyl)phosphite, tris(2-[(2,4,8,10-tetrakis-tert-butyldibenzo[d,f][1,3,2]dioxaphosphepin-6-yl)oxy]ethyl)amine, 3,9-bis(4-nonylphenoxy)-2,4,8,10-tetraoxa-3,9-diphosphaspiro[5,5]undecane, 2,4,6-tri-tert-butylphenyl-2-butyl-2-ethyl-1,3-propanediol phosphite, poly-4,4′-isopropylidene diphenol C12-15 alcohol phosphite, and phosphite of 2-ethyl-2-butylpropylene glycol and 2,4,6-tri-tert-butylphenol.

Examples of the thioether-based antioxidant include tetrakis[methylene-3-(laurylthio)propionate]methane, bis(methyl-4-[3-n-alkyl(C12/C14)thiopropionyloxy]-5-tert-butylphenyfisulfide, ditridecyl-3,3′-thiodipropionate, dilauryl-3,3′-thiodipropionate, dimyristyl-3,3′-thiodipropionate, distearyl-3,3′-thiodipropionate, lauryl/stearyl thiodipropionate, 4,4′-thiobis(6-tert-butyl-m-cresol), 2,2′-thiobis(6-tert-butyl-p-cresol) and distearyl disulfide.

Examples of the ultraviolet absorber include 2-hydroxybenzophenones such as 2,4-dihydroxybenzophenone, 2-hydroxy-4-methoxybenzophenone, 2-hydroxy-4-octoxybenzophenone and 5,5′-methylene-bis(2-hydroxy-4-methoxybenzophenone); 2-(2-hydroxyphenyl)benzotriazoles such as 2-(2-hydroxy-5-methylphenyl)benzotriazole, 2-(2-hydroxy-5-tert-octylphenyl)benzotriazole, 2-(2-hydroxy-3,5-di-tert-butylphenyl)-5-chlorobenzotriazole, 2-(2-hydroxy-3-tert-butyl-5-methylphenyl)-5-chlorobenzotriazole, 2-(2-hydroxy-3,5-dicumylphenyl)benzotriazole, 2,2′-methylene-bis(4-tert-octyl-6-benzotriazolylphenol), polyethylene glycol ester of 2-(2-hydroxy-3-tert-butyl-5-carboxyphenyl)benzotriazole, 2-[2-hydroxy-3-(2-acryloyloxyethyl)-5-methylphenyl]benzotriazole, 2-[2-hydroxy-3-(2-methacryloyloxyethyl)-5-tert-butylphenyl]benzotriazole, 2-[2-hydroxy-3-(2-methacryloyloxyethyl)-5-tert-octylphenyl]benzotriazole, 2-[2-hydroxy-3-(2-methacryloyloxyethyl)-5-tert-butylphenyl]-5-chlorobenzotriazole, 2-[2-hydroxy-5-(2-methacryloyloxyethyl)phenyl]benzotriazole, 2-[2-hydroxy-3-tert-butyl-5-(2-methacryloyloxyethyl)phenyl]benzotriazole, 2-[2-hydroxy-3-tert-amyl-5-(2-methacryloyloxyethyl)phenyl]benzotriazole, 2-[2-hydroxy-3-tert-butyl-5-(3-methacryloyloxypropyl)phenyl]-5-chlorobenzotriazole, 2-[2-hydroxy-4-(2-methacryloyloxymethyl)phenyl]benzotriazole, 2-[2-hydroxy-4-(3-methacryloyloxy-2-hydroxypropyl)phenyl]benzotriazole and 2-[2-hydroxy-4-(3-methacryloyloxypropyl)phenyl]benzotriazole; 2-(2-hydroxyphenyl)-4,6-diaryl-1,3,5-triazines such as 2-(2-hydroxy-4-methoxyphenyl)-4,6-diphenyl-1,3,5-triazine, 2-(2-hydroxy-4-hexyloxyphenyl)-4,6-diphenyl-1,3,5-triazine, 2-(2-hydroxy-4-octoxyphenyl)-4,6-bis(2,4-dimethylphenyl)-1,3,5-triazine, 2-[2-hydroxy-4-(3-C12 to 13 mixed alkoxy-2-hydroxypropoxy)phenyl]-4,6-bis(2,4-dimethylphenyl)-1,3,5-triazine, 2-[2-hydroxy-4-(2-acryloyloxyethoxy)phenyl]-4,6-bis(4-methylphenyl)-1,3,5-triazine, 2-(2,4-dihydroxy-3-allylphenyl)-4,6-bis(2,4-dimethylphenyl)-1,3,5-triazine and 2,4,6-tris(2-hydroxy-3-methyl-4-hexyloxyphenyl)-1,3,5-triazine; benzoates such as phenyl salicylate, resorcinol monobenzoate, 2,4-di-tert-butylphenyl-3,5-di-tert-butyl-4-hydroxybenzoate, octyl(3,5-di-tert-butyl-4-hydroxy)benzoate, dodecyl(3,5-di-tert-butyl-4-hydroxy)benzoate, tetradecyl(3,5-di-tert-butyl-4-hydroxy)benzoate, hexadecyl(3,5-di-tert-butyl-4-hydroxy)benzoate, octadecyl(3,5-di-tert-butyl-4-hydroxy)benzoate and behenyl(3,5-di-tert-butyl-4-hydroxy)benzoate; substituted oxanilides such as 2-ethyl-2′-ethoxyoxanilide and 2-ethoxy-4′-dodecyloxanilide; cyanoacrylates such as ethyl-α-cyano-β,β-diphenyl acrylate and methyl-2-cyano-3-methyl-3-(p-methoxyphenyl)acrylate; and various metal salts and metal chelates, particularly salts and chelates of nickel and chromium.

Examples of the hindered amine compound include 2,2,6,6-tetramethyl-4-piperidyl stearate, 1,2,2,6,6-pentamethyl-4-piperidyl stearate, 2,2,6,6-tetramethyl-4-piperidyl benzoate, bis(2,2,6,6-tetramethyl-4-piperidyl)sebacate, tetrakis(2,2,6,6-tetramethyl-4-piperidyl)-1,2,3,4-butane tetracarboxylate, tetrakis(1,2,2,6,6-pentamethyl-4-piperidyl)-1,2,3,4-butane tetracarboxylate, bis(2,2,6,6-tetramethyl-4-piperidyl).di(tridecyl)-1,2,3,4-butane tetracarboxylate, bis(1,2,2,6,6-pentamethyl-4-piperidyl).di(tridecyl)-1,2,3,4-butane tetracarboxylate, bis(1,2,2,4,4-pentamethyl-4-piperidyl)-2-butyl-2-(3,5-di-tert-butyl-4-hydroxybenzyl)malonate, 1-(2-hydroxyethyl)-2,2,6,6-tetramethyl-4-piperidinol/diethyl succinate polycondensate, 1,6-bis(2,2,6,6-tetramethyl-4-piperidylamino)hexane/2,4-dichloro-6-morpholino-s-triazine polycondensate, 1,6-bis(2,2,6,6-tetramethyl-4-piperidylamino)hexane/2,4-dichloro-6-tert-octylamino-s-triazin e polycondensate, 1,5,8,12-tetrakis[2,4-bis(N-butyl-N-(2,2,6,6-tetramethyl-4-piperidyl)amino)-s-triazine-6-yl]-1, 5,8,12-tetraazadodecane, 1,5,8,12-tetrakis[2,4-bis(N-butyl-N-(1,2,2,6,6-pentamethyl-4-piperidyl)amino)-s-triazine-6-yl]-1,5,8,12-tetraazadodecane, 1,6,11-tris[2,4-bis(N-butyl-N-(2,2,6,6-tetramethyl-4-piperidyl)amino)-s-triazine-6-yl]aminoun decane, 1,6,11-tris[2,4-bis(N-butyl-N-(1,2,2,6,6-pentamethyl-4-piperidyl)amino)-s-triazine-6-yl]amino undecane, bis{4-(1-octyloxy-2,2,6,6-tetramethyl)piperidyl}decanedionate and bis{4-(2,2,6,6-tetramethyl-1-undecyloxy)piperidyl}carbonate.

Examples of the flame retardant include aromatic phosphates such as triphenyl phosphate, tricresyl phosphate, trixylenyl phosphate, cresyldiphenyl phosphate, cresyl-2,6-xylenyl phosphate, resorcinol-bis(diphenylphosphate), (1-methylethylidene)di-4,1-phenylenetetraphenyl diphosphate, 1,3-phenylene-tetrakis(2,6-dimethylphenyl)phosphate, ADK STAB FP-500 (manufactured by ADEKA Corporation), ADK STAB FP-600 (manufactured by ADEKA Corporation) and ADK STAB FP-800 (manufactured by ADEKA Corporation); phosphonates such as divinyl phenylphosphonate, diallyl phenylphosphonate and (1-butenyl)phenylphosphonate; phosphinates such as phenyl diphenylphosphinate, methyl diphenylphosphinate and 9,10-dihydro-9-oxa-10-phosphaphenanthlene-10-oxide derivatives; phosphazene compounds such as bis(2-allylphenoxy)phosphazene and dicresylphosphazene; phosphorus-based flame retardants such as melamine phosphate, melamine pyrophosphate, melamine polyphosphate, melam polyphosphate, ammonium polyphosphate, piperazine phosphate, piperazine pyrophosphate, piperazine polyphosphate, phosphorus-containing vinylbenzyl compounds and red phosphorus; metal hydroxides such as magnesium hydroxide and aluminum hydroxide; and bromine-based flame retardants such as brominated bisphenol A-type epoxy resins, brominated phenol novolac-type epoxy resins, hexabromobenzene, pentabromotoluene, ethylene-bis(pentabromophenyl), ethylene-bis-tetrabromophthalimide, 1,2-dibromo-4-(1,2-dibromoethyl)cyclohexane, tetrabromocyclooctane, hexabromocyclododecane, bis(tribromophenoxy)ethane, brominated polyphenylene ether, brominated polystyrene, 2,4,6-tris(tribromophenoxy)-1,3,5-triazine, tribromophenyl maleimide, tribromophenyl acrylate, tribromophenyl methacrylate, tetrabromobisphenol A-type dimethacrylate, pentabromobenzyl acrylate and brominated styrene. These flame retardants are preferably used in combination with a drip inhibitor such as a fluorocarbon resin and/or a flame retardant aid such as a polyhydric alcohol or hydrotalcite.

Examples of the nucleating agent other than those represented by the Formula (1) or (2) include metal carboxylates such as sodium benzoate, aluminum-4-tert-butylbenzoate, sodium adipate and 2-sodium-bicyclo[2.2.1]heptane-2,3-dicarboxylate; and amide compounds such as N,N′,N″-tris[2-methylcyclohexyl]-1,2,3-propane tricarboxamide, N,N′,N″-tricyclohexyl-1,3,5-benzene tricarboxamide, N,N′-dicyclohexyl-naphthalene dicarboxamide and 1,3,5-tri(dimethylisopropoylamino)benzene.

Preferable examples of the filler include talc, mica, calcium carbonate, calcium oxide, calcium hydroxide, magnesium carbonate, magnesium hydroxide, magnesium oxide, magnesium sulfate, aluminum hydroxide, barium sulfate, glass powder, glass fibers, clays, dolomite, silica, alumina, potassium titanate whiskers, wollastonite and fibrous magnesium oxysulfate. Among these fillers, those having an average particle size (in the case of a spherical or plate-form filler) or an average fiber diameter (in the case of a needle-form or fibrous filler) of 5 μm or less are preferred.

The lubricant is added for the purposes of imparting the surface of the resulting molded article with lubricity and improving the damage-preventing effect. Examples of such lubricant include unsaturated fatty acid amides such as oleic acid amide and erucic acid amide; saturated fatty acid amides such as behenic acid amide and stearic acid amide; butyl stearate; and silicone oils.

The antistatic agent is added for the purposes of reducing the electrostaticity of the resulting molded article and inhibiting dust adhesion caused by electrostatic charge. Examples of such antistatic agent include cationic, anionic and non-ionic antistatic agents. Preferred examples thereof include polyoxyethylene alkylamines, polyoxyethylene alkylamides, fatty acid esters thereof, and glycerin fatty acid esters.

The amount of such other additives to be used in the present invention is preferably in the range of from an amount at which the effect of the addition is exerted to an amount at which an improvement in the effect of the addition is no longer observed. Preferred amounts of the respective additives to be used with respect to 100 parts by mass of a polyolefin-based resin are as follows: 0.1 to 20 parts by mass of a plasticizer(s), 1 to 50 parts by mass of a filler(s), 0.001 to 1 part by mass of a surface treatment agent(s), 0.001 to 10 parts by mass of a phenolic antioxidant(s), 0.001 to 10 parts by mass of a phosphorus-based antioxidant(s), 0.001 to 10 parts by mass of a thioether-based antioxidant(s), 0.001 to 5 parts by mass of a ultraviolet absorber(s), 0.01 to 1 part by mass of a hindered amine compound(s), 1 to 50 parts by mass of a flame retardant(s), 0.03 to 2 parts by mass of a lubricant(s), and 0.03 to 2 parts by mass of an antistatic agent(s). These additives may be used individually, or two or more thereof may be used in combination.

The polyolefin resin packaging material of the present invention can be molded into various shapes by conventionally known various molding methods such that the resulting molded article has physical properties suitable as a packaging material.

Examples of the shapes include those of packaging materials that are conventionally and usually used, such as a sheet shape, a cylindrical shape, a bottle shape and a box shape.

As the molding method, for example, a method in which, after mixing with stirring the polyolefin-based resin, the nucleating agents represented by the Formulae (1) and (2) and an additive(s) to be added as required using a mixer, the resulting mixture is melt-kneaded and extruded into a pellet using an extruder and this pellet is then molded by extrusion molding, injection molding, compression molding, sheet molding, blow molding, vacuum molding, rotomolding or the like to obtain a desired molded article is usually employed. Alternatively, these components may be directly molded without the pelletization step, and a molding method such as casting can also be employed as appropriate. Further, a masterbatch is prepared by concentrating the components to be added at a high concentration and a molded article can be produced with an addition of this masterbatch during the molding process.

The clear thin-walled molded article, which is a preferred mode of the polyolefin resin packaging material of the present invention, is a molded article of 1 mm or less in thickness which is obtained by injection molding using a known injection molding machine, and examples of such a molded article include those of about 0.1 to 1 mm in thickness. By reducing the thickness, weight reduction of the molded article can be easily achieved, which greatly contributes to material and resource conservation. Moreover, since the molded article can be easily cooled in the molding step, the molding cycle can be largely shortened, so that energy saving can be achieved. These enable to greatly reduce the burden on the environment. On the other hand, a reduction in the thickness of a molded article leads to a reduction in the rigidity; therefore, it is indispensable to impart the molded article with rigidity. However, since the clear thin-walled molded article of the present invention has excellent physical properties, the polyolefin resin packaging material of the present invention can be easily reduced in thickness as an injection molded article.

The clear thick-walled molded article, which is also a preferred mode of the polyolefin resin packaging material of the present invention, is a molded article of more than 1 mm in thickness which is obtained by injection molding using a known injection molding machine and, in cases where a clear material is desired, the molded article has a thickness of, for example, 5 mm or less. Generally speaking, when a molded article has a large thickness, since the cooling rate is different between the surface and the interior of the molded article in the molding step, large crystals of polyolefin are generated inside the molded article and the clarity of the molded article is thereby reduced. However, by incorporating a dibenzylidene sorbitol compound represented by the Formula (1) and a metal phosphate represented by the Formula (2) at a specific ratio, the crystallization rate of the polyolefin is markedly improved, making the difference in the crystallization rate of the polyolefin between the interior and the surface of the resulting molded article small, and a thick-walled molded article having excellent clarity can be obtained as a result.

Examples of a molded article in which the effects of the present invention can be exerted include food containers (e.g., pudding containers, jelly containers, yogurt containers, other dessert containers, ready-prepared food containers, cup-steamed hotchpotch containers, instant noodle containers, rice containers, retort containers and lunch box containers), beverage containers (e.g., beverage bottles, chilled coffee containers, one-hand cup containers and other beverage containers), caps (e.g., PET bottle caps, one-piece caps, two-piece caps, instant coffee caps, seasoning caps, cosmetic container caps and hinge caps), pharmaceutical containers (e.g., pre-filled syringes, kit pharmaceuticals, eye drop containers, drug solution containers, drug containers, long-term storage containers for liquids and plastic vials), various other containers (e.g., ink containers, cosmetic containers, shampoo containers and detergent containers), medical instruments (e.g., disposable syringes and parts thereof, disposable instruments such as blood circuits, components of artificial organs such as artificial lungs and artificial anus, dialyzers, test tubes, components of dental materials, components of orthopedic materials, and contact lens cases), and daily necessaries (e.g., wardrobe cases, buckets, washbowls, writing utensils, containers, toys, kitchen utensils and other various cases).

Examples of the above-described electrical/electronic component transport case include members and chassis of electrical appliances, semiconductor transport containers, those of optical components, various information medium cases and solar cell sealants.

Examples of the above-described food storage container include those food containers and beverage containers that are exemplified above.

### EXAMPLES

The present invention will now be described more concretely by way of examples thereof; however, the present invention is not restricted to the following examples and the like by any means.

Using a Henschel mixer (FM200; manufactured by Mitsui Mining Co., Ltd.), 100 parts by mass of an ethylene/propylene random copolymer having a melt flow rate of 8 WI 0 min as a polyolefin-based resin was mixed with 0.026 parts by mass of di(t-butylperoxy)diisopropylbenzene as a peroxide, 0.1 parts by mass of tetrakis[methylene-3-(3′,5′-di-tert-butyl-4′-hydroxyphenyl)propionate]methane as a phenolic antioxidant, 0.1 parts by mass of tris(2,4-di-tert-butylphenyl)phosphite as a phosphorus-based antioxidant, 0.05 parts by mass of calcium stearate and 0.2 parts by mass of the respective nucleating agent compositions shown in Table 1 below, at 1,000 rpm for 1 minute. Then, using a uniaxial extruder (OEX3024; manufactured by DDM Co., Ltd.), the resulting mixtures were each extruded under processing conditions of a temperature of 240° C. and a screw speed of 30 rpm to produce a pellet. The thus obtained pellets all had a melt flow rate of 42 g/10 min. These pellets were subjected to the below-described evaluations. In Table 1 below, the symbols used for the nucleating agent composition each corresponds to the above-exemplified benzylidene sorbitol compound represented by the Formula (1) or metal phosphate represented by the Formula (2).

### (Haze)

Using an injection molding machine (EC100-2A; manufactured by Toshiba Machine Co., Ltd.), the thus obtained pellets were each filled into a die for 40 seconds at an injection temperature of 200° C. and an injection pressure of 70 to 80 MPa and subsequently cooled for 20 seconds in the die at 40° C. The resultant was then injection-molded under conditions for drawing a sheet from the die, thereby obtaining a 1 mm-thick square sheet of 60 mm×60 mm in size. Immediately thereafter, this sheet was left to stand in an incubator having an inner temperature of 23° C. for at least 48 hours, and the haze of the test piece was determined using Haze Guard II (manufactured by Toyo Seiki Seisaku-sho, Ltd.). A lower haze value indicates superior clarity of the test piece. The results thereof are shown in Table 1 below.

### (Deflection Temperature Under Load)

Using an injection molding machine (EC100-2A; manufactured by Toshiba Machine Co., Ltd.), the pellets obtained above were each filled into a die for 40 seconds at an injection temperature of 200° C. and an injection pressure of 70 to 80 MPa and subsequently cooled for 20 seconds in the die at 40° C. The resultant was then injection-molded under conditions for drawing a sheet from the die to prepare a test piece of 80 mm×10 mm×4 mm in size, and the deflection temperature under load (HDT) of the test piece was measured in accordance with ISO 75 (load: 0.45 MPa). The results thereof are shown in Table 1 below.

### (Odor Property)

A rating sensory evaluation was conducted in accordance with JIS Z9080: Sensory Analysis. To a 6-L polyethylene terephthalate sachet, 100 g of a 500 μm-thick film prepared in advance by press-molding each of the pellets obtained above was added along with odorless air obtained through active carbon and, after storing the sachet for 7 days at a room temperature of 23° C. and a humidity of 50%, sensory evaluation of the air inside the sachet was performed by five panelists. An evaluation “x” was given when a strong odor was sensed; an evaluation “Δ” was given when an odor was sensed; and an evaluation “∘” was given when no odor was sensed. The results thereof are shown in Table 1 below.

### (Bleed Resistance)

The bleed resistance was evaluated based on the difference between the haze value measured for a 500 μm-thick film, which was prepared by press-molding each of the pellets obtained above and storing the resultant for 7 days in a 80° C. Geer oven, and the haze value measured after washing the film surface with ethanol. A larger value means a greater amount of bleeding, while a smaller value means superior bleed resistance. This evaluation can be used as an index of the appropriateness for the use in a case where long-term storage is required. The results thereof are shown in Table 1 below.

TABLE 1

| | Nucleating agent composition | | | | Evaluation | | | |
|---|---|---|---|---|---|---|---|---|
| | Benzylidene | | | | | Deflection | | |
| | sorbitol | Amount | Metal | Amount | | temperature | Odor | Bleed |
| | compound | [parts by mass] | phosphate | [parts by mass] | Haze [%] | under load [° C.] | property | resistance |
| Example 1 | S-1 | 0.1 | P-2 | 0.1 | 8.3 | 70.1 | ∘ | 8.8 |
| Comparative | S-1 | 0.2 | — | — | 9.8 | 70.0 | Δ | 10.6 |
| Example 1 | | | | | | | | |
| Comparative | S-8 | 0.2 | — | — | 10.0 | 68.5 | Δ | 12.7 |
| Example 2 | | | | | | | | |
| Comparative | S-3 | 0.2 | — | — | 8.8 | 69.0 | x | 9.3 |
| Example 3 | | | | | | | | |

According to the results of Comparative Examples 1 to 3, in the molded articles comprising only a benzylidene sorbitol compound represented by the Formula (1), the clarity, heat resistance and bleed resistance were not satisfactory and generation of an odor was observed. On the other hand, the molded article of the present invention comprising a benzylidene sorbitol compound represented by the Formula (1) and a metal phosphate represented by the Formula (2) at a specific ratio was confirmed to have a low-odor property and exhibit excellent clarity, heat resistance and low-contamination property. The polyolefin resin packaging material of the present invention exhibits excellent low-contamination property under a high-temperature environment.

1. A polyolefin resin packaging material obtained by molding a polyolefin-based resin composition,
said polyolefin-based resin composition comprising, with respect to 100 parts by mass of a polyolefin-based resin:
0.01 to 0.5 parts by mass of a benzylidene sorbitol compound represented by the following Formula (1): 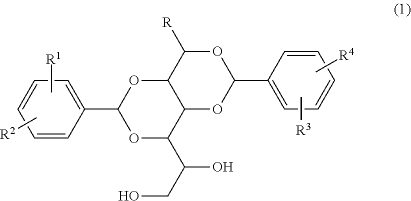
(wherein, R represents a hydrogen atom or an alkyl group having 1 to 4 carbon atoms; and R¹, R², R³ and R⁴ each independently represent a hydrogen atom, a halogen atom, a cyano group or an alkyl group having 1 to 4 carbon atoms); and
0.01 to 0.5 parts by mass of a metal phosphate represented by the following Formula (2): 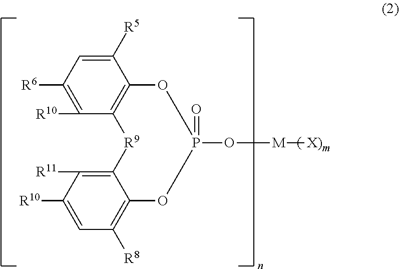
(wherein, R⁵ and R⁸ each independently represent an alkyl group having 1 to 8 carbon atoms, or a cycloalkyl, aryl, alkylaryl or arylalkyl group having 6 to 12 carbon atoms; R⁶ and R⁷ each independently represent a hydrogen atom, an alkyl group having 1 to 8 carbon atoms, or a cycloalkyl, aryl, alkylaryl or arylalkyl group having 6 to 12 carbon atoms; R⁹ represents a direct bond or an alkylidene group having 1 to 4 carbon atoms; R¹⁰ and R¹¹ each independently represent a hydrogen atom or a methyl group; M represents an atom of an alkali metal, an alkaline earth metal, zinc or aluminum; n represents an integer of 1 to 3; m represents an integer of 0 to 2; when M is an alkali metal, n is 1 and m is 0; when M is an alkaline earth metal or zinc, X is a hydroxy group and m is 1 if n is 1, and m is 0 if n is 2; and when M is aluminum, m is 2 if n is 1, m is 1 if n is 2, with X being a hydroxy group in both of these cases, and m is 0 if n is 3).

2. The polyolefin resin packaging material according to claim 1, wherein the blending ratio of said compound represented by said Formula (1) and said compound represented by said Formula (2), said compound represented by said Formula (1)/said compound represented by said Formula (2), is 20/1 to 1/4.

3. The polyolefin resin packaging material according to claim 1, which is a clear thin-walled molded article.

4. The polyolefin resin packaging material according to claim 1, which is a clear thick-walled molded article.

5. The polyolefin resin packaging material according to claim 1, which is an electrical/electronic component transport case.

6. The polyolefin resin packaging material according to claim 1, which is a food storage container.
